(19) United States
(12) Patent Application Publication
(10) Pub. No.: US 2002/0173191 A1
(43) Pub. Date: Nov. 21, 2002

(54) Cable connector with improved assembly structure and pull-out resistance

(76) Inventor: Ho I-Tse, Tai Nan (TW)

Correspondence Address: MOLEX INCORPORATED, 2222 WELLINGTON COURT, LISLE, IL, 60532, US

(21) Appl. No.: 10/109,751

(22) Filed: Mar. 29, 2002

(30) Foreign Application Priority Data
Mar. 30, 2001 (TW) 090204921
Mar. 30, 2001 (TW) 090204922

(51) Int. Cl. H01R 13/62; H01R 12/24

(52) U.S. Cl. 439/329; 439/492

(57) ABSTRACT

A cable connector having an improved assembly includes a housing, with a recess, a cover plate and a cable. The cover plate has fastening members extending down along two sides thereof and another fastening member at its front end. The connector housing has first latch openings aligned with the first fastening members and a second latch opening that is aligned with the other fastening member. After the wires of the cable are soldered to the terminals of the connector, the first fastening members are brought downward along interior surfaces of the housing recess to engage the first latch openings, with the other fastening member simultaneously engaging the second latch opening to join the cover plate to the housing. Another aspect of the invention concerns the use of an extension portion formed with the housing and extending underneath the terminal termination portions to support them. A protective strain relief is overmolded to the housing and extension portion.

### BACKGROUND OF THE INVENTION

The present invention relates generally to cable connectors, and more particularly to cable connectors that are formed from two components, and which offers ease of assembly and greater assembly speed, and which have a structure that resists fatigue and breakage of soldering points between cable wires and terminations due to repeated plugging and unplugging by providing optimal pull resistance.

As the performance of electronics devices is being constantly enhanced and their dimensions are being reduced, connector layouts are becoming subject to tighter physical constraints. As a result, cable connectors that provide for signal transmission are being developed in more compact and lightweight designs. At the same time, there is a demand that cable connector assembly be as simple, rapid, and consistent as possible to increase production efficiency.

However, present cable connectors have the following shortcomings. The cable wires may be easily dislodged from the connector pins. When the wires of the cable are soldered to the pins of the connector, the small size of the two components makes soldering difficult. The actual usage of the cable connector involves repeated plugging and unplugging, and if the transfer of direct force to the connector pins is not circumvented, the wires can be easily pried off the pins or their termination portions within the connector, which renders the connector unusable.

Additionally, most conventional connector housings tend to loosen following assembly. Since the housing of the connector is typically of a snap-fit structure, a poor snap-fit design leads to a gradual loss of engagement integrity following a period of usage and results in defective products.

During the plastic liquefaction phase of cable connector production, cable severing and excessive molten plastic flow readily occur. Since an insulating material must be applied over the cable wires and pins after soldering is completed to prevent short circuiting, this is typically accomplished with liquefied plastic. However, if the force of liquefied plastic application is too extreme, the wires of the cable often break and the entire assembly can only be discarded since re-fabrication and correction are not possible.

FIG. 1 illustrates an insulated housing 10a of a conventional cable connector 1a that has a relatively wide structure and given the current emphasis on compact dimensions and, furthermore, high-speed transmission capacity, it is incapable of satisfying modern user requirements.

The present invention is directed to a cable connector that effectively solves the said shortcomings.

### SUMMARY OF THE INVENTION

Accordingly, it is a general object of the present to provide a cable connector having a two-component assembly, wherein after the wires of the cable are soldered to the pin leads, the cover plate may be snap-fitted and joined onto the housing, thereby facilitating ease of assembly as well as greater assembly speed.

Another object of the present invention is to provide a cable connector having an insulated housing with an extension block projecting from its termination end, the extension block providing for the adhesion of the protective cover molded thereto so that the connector housing and cover portion do not become separated due to repeated plugging and unplugging, thereby effecting a durable joining of the connector housing to the cable.

In order to accomplish these objects, a cable connector of the present invention is provided by way of a cover plate, housing, and a cable. The cover plate includes a fastening member extending downward from its two sides, and with a first latch tab projecting outward from the ends of the fastening members. A second latch tab that extends forward from the anterior end of the cover plate is provided and, the cover plate has an upper holding mount formed at its posterior end. The housing has a pin section and a cable section, and the pin section includes pin channels that provide for the insertion of a plurality of pin leads. First latch holes are formed in the lower edge of the two side walls of the cable section and that are aligned with the first latch tabs, while second latch holes are formed at the top of the cable section rear end and are aligned with the said second latch tabs. The housing has a lower holding mount formed at its posterior end.

As such, the plurality of wires in the cable are connected to the pin leads by soldering, following which the first latch tabs are brought downward along the interior surfaces of the housing side walls to engage the first latch holes, and the second latch tabs simultaneously engage the second latch holes to join the cover plate and the housing together into a single structural unit. The end of the cable is then clamped between the upper and lower holding mounts and the exterior cover of the connector is subsequently molded over it to form an encapsulating strain relief, which thereby completes the assembly of the cable connector of the present invention.

In another aspect of the present invention, an insulated housing is provided to which the cable is coupled and positioned within. The cable encloses a plurality of wires and the insulated housing has a plurality of built-in pin channels which receive individual terminal leads which are each respectively inserted in alignment such that the terminal leads can be correspondingly soldered to the cable wires. The extension block projects from the termination ends of the terminals, i.e., the terminal leads. A plurality of grooves are formed along the surface of the extension block. When a protective cover, or encasement, is molded over the extension block, the molding material fills the extension block grooves and this engagement increases the strength between the housing and the encasement, thereby preventing the loosening of the encasement due to forces applied to the cable connector during repeated plugging and unplugging so that the soldering points between the wires and the termination leads remain unaffected and reliable.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is an isometric drawing of a conventional cable connector;

FIG. 2 is an exploded perspective view of one embodiment of a cable connector (with an angled connector end) constructed in accordance with the principles of the present invention;

FIG. 3 is the same view as FIG. 2, but with the components assembled together;

FIG. 4 is an exploded perspective view of a second embodiment of a cable connector (withe an in-line connector end) constructed in accordance with the principles of the present invention;

FIG. 5 is the same view as FIG. 4, but with the connector components assembled together;

FIG. 6 is a diagram that illustrates the pressure reduction principle accomplished by use with the present invention;

FIG. 7 is an exploded perspective view of another embodiment of a cable connector constructed in accordance with the principles of the present invention and having a right-angle configuration;

FIG. 8 is the same view as FIG. 7, but in a final, assembled condition;

FIG. 9 is an exploded perspective view of still another embodiment of a cable connector constructed in accordance with the principles of the present invention and having an in-line configuration; and,

FIG. 10 is the same view as FIG. 9, but in a fully assembled condition.

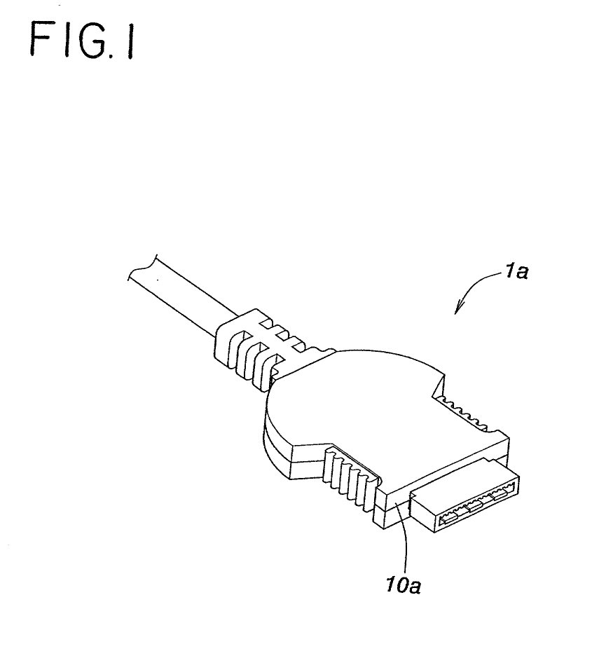

### DETAILED DESCRIPTION OF THE PREFERRED EMBODIMENTS

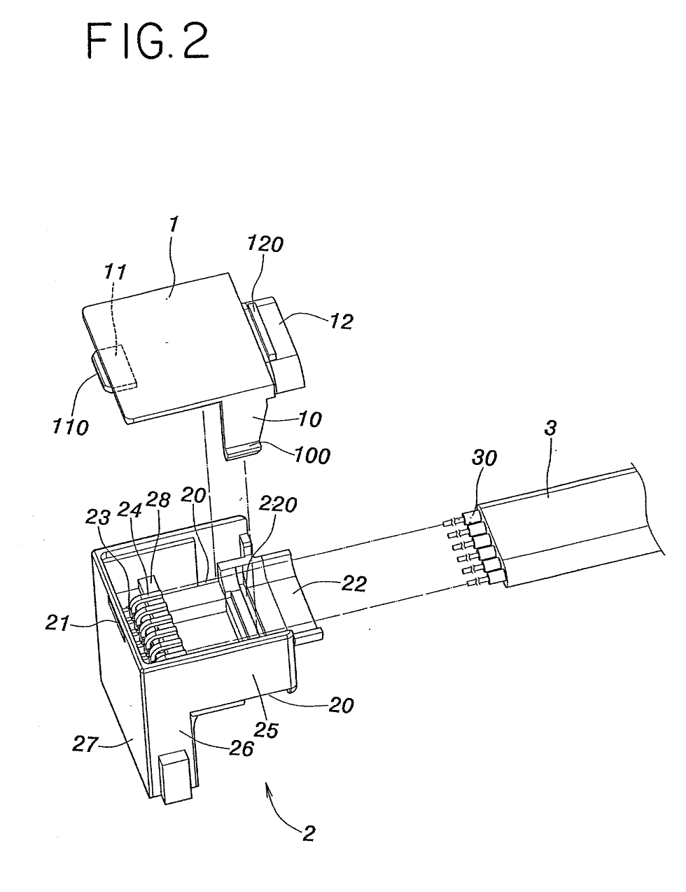

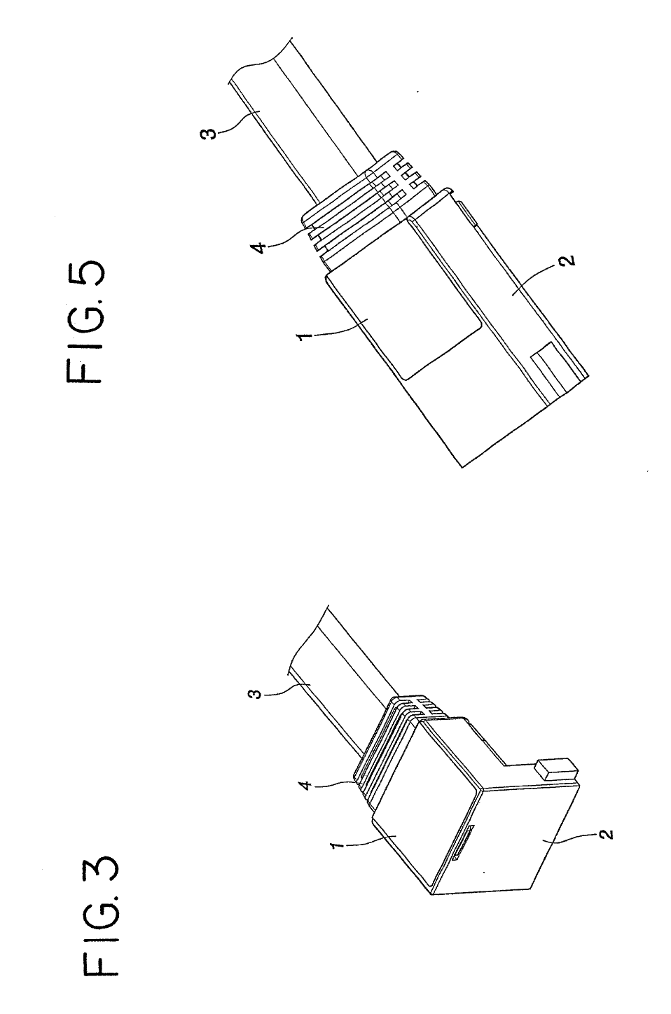

Referring first to FIGS. 2 and 3, they illustrate one embodiment of a cable connector constructed in accordance with the principles of the present invention. This embodiment has an angled connector end, and more specifically an end in which the connector pins are oriented at about 90 degrees from the individual cable wires 30 of the cable 3 to which it is terminated. The connector assembly includes an insulative housing 2 and a cover plate 1 that mates therewith.

The cover plate 1 has a flat, preferably planar cover portion having two fastening members 10 that depend downwardly from the cover portion for a preselected length along each of the two sides of the cover plate 1. Each fastening member includes a first latch tab 100 that projects outwardly from the ends of the fastening members 10. Another fastening member 11 extends forward from the anterior, or forward, end of the cover plate 1 and it has a second latch tab 110 projecting straight ahead from the said fastening member 11, and a U-shaped upper holding mount 12 formed at the posterior end of the cover plate 1.

The housing 2 may be considered as divided into a pin section and a cable section, wherein the pin section and the cable section are joined together in a perpendicular arrangement. The pin section includes a plurality of pin channels, or grooves, 23 that contain a plurality of conductive pins or terminals, and each of the terminals having termination leads 24 dat the rear ends of the pins such that the leads 24 extend a certain distance from the pin section before they are bent, preferably at a right angle. The forward ends of the terminals are not shown, but they project into a socket at the forward end of the connector, which is also not shown, for mating with an opposing connector. The side walls 25 of the cable section and the side walls 26 of the pin section of the connector merge together into an L-shape and, furthermore, an opening is formed at the end of the said cable section, the shape of which matches that of the ensconcing structure of the said cover plate 1.

A pair of first latch holes 20 are formed at a suitable area at the lower edge of each said cable section side walls 25 and these holes 20 receive their corresponding opposing first latch tabs 100. A second latch hole 21 is formed at the top of the cable section end plate 27 and receives the second latch tab 110 therein such that three points of fastening contact are defined between the cover plate and the connector body. The three latch holes are disposed in different directions. For example, the first latch holes 20 run aong the edges of the housing 2 extend generally parallel to a longitudinal axis of the housing 2 or the cable 3, while the second latch hole 21 extends crosswise, and preferably generally perpendicular thereto. Still further, the first latch holes 20 are spaced apart from the second latch hole 21 in the vertical direction a chosen distance L1 which matches the distance L2 which is the spacing between the first latch tabs 100 and the second latch tab 110.

Additionally, a support plate 28 is provided within an appropriate area of the cable section and it extends crosswise with respect to the wires, in order to facilitate the soldering of the cable 3 to the exposed terminal termination leads 24. A lower holding mount 22 that has a configuration that matches that of the upper holding mount 12 of the cover plate is formed at the rear end of the cable section, and these upper and lower holding mounts 12 and 22 are capable of reliably clamping the end of the cable 3. The cable 3 includes a plurality of wires 30 that are positioned within the cable section of the connector and the wires 30 are then correspondingly soldered to the termination leads 24.

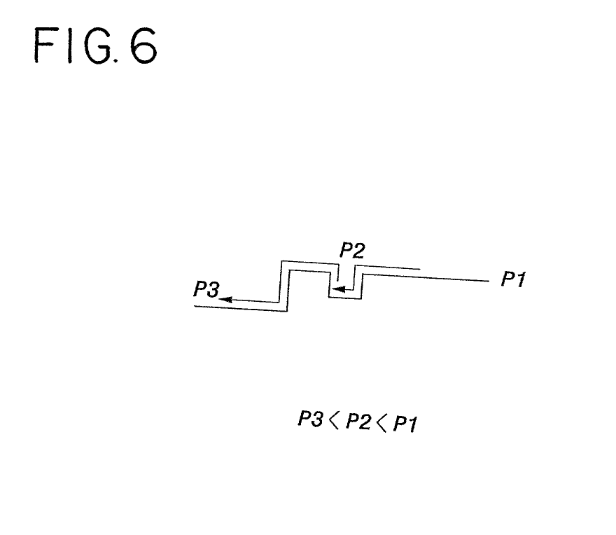

A plurality of ridges 120 may be formed horizontally along the exterior surfaces of the upper and lower holding mounts 12 and 22 such that when molding plastic liquefies and flowsinto the mold, the ridges 120 provide for the clinging of the molten plastic such that when hardened, the joining together of the two pieces is optimal. A plurality of uneven height grooves 220 are formed horizontally along the interior surfaces of the upper and lower holding mounts 12 and 22 and are further disposed in a shallow to deep arrangement from the outside in such that during plastic liquefaction, a gradual pressure reduction results in the formation of the connector, wherein P3<P2<P1<, as indicated in FIG. 6.

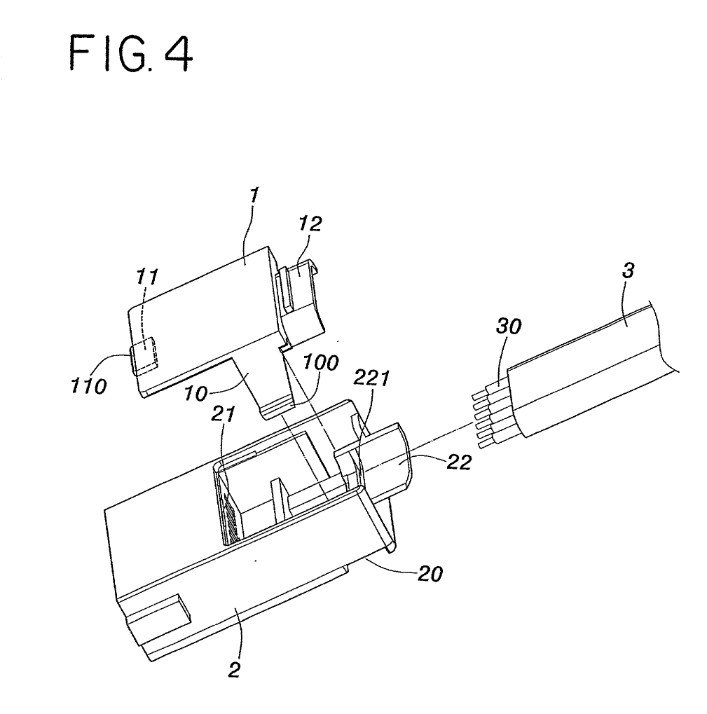

Referring now to FIGS. 4 and 5, a second embodiment of the invention is illustrated in which the cable connector 1 is of the “in-line” style, and does not have any right-angle or other bend. It includes a cover plate 1, a housing 2, and a cable 3. In this embodiment, the pin section and the cable section of the connector are joined together in a linear arrangement and are aligned along a common axis. In this manner, the terminal leads 24 extend from the said pin section in a horizontal array straight into the said cable section. Other than that, the remaining structure is the same as that described for the first embodiment.

It will be understood that this embodiment is also a two-component assembly arrangement and when assembled, the end of the said cable 3 is first placed in the lower holding mount 22 of the housing 2, the wires 30 of the said cable 3 are then respectively connected to the said pin leads 24 by soldering. Relying on the resilience of the fastening member 10 at the two sides of the cover plate 1, the first latch tabs 100 are guided downward against the interior surface of the housing side walls 25 until the first latch tabs 100 pass through the first latch holes 20 of the housing 2 and the second latch tab 110 of the said fastening member 11 simultaneously is inserted through the second latch hole 21 of the housing 2 to enable a tight snap-fit that joins the cover plate 1 onto the housing 2. Finally, in order to prevent excessive flexing and for protective purposes, an exterior strain relief 4 is molded over the rear ends 12, 22 of the connector parts 1, 2, and the strain relief 4 provides a means of attachment between the said upper and lower holding mounts 12 and 22 and the said cable 3 (as shown in FIG. 3 and FIG. 5), which thereby completes its assembly.

The cable connectors of the present invention possess the following advantages. Firstly, they have a simple two-component assembly. After the wires 30 of the cable 3 are soldered to the terminal leads 24, the cover plate 1 is snap-fitted and joined to the housing 2, thereby facilitating ease of assembly as well as greater assembly speed to achieve of an objective of increasing production capacity. The pressure reduction grooves 220 are formed at varying heights along the said upper and lower holding mounts 12 and 22 so that during the overmolding fabrication process, pressure reduction is effectively accomplished to prevent excessive pressure that results in plastic flow into the pin channels 23 of the housing 2.

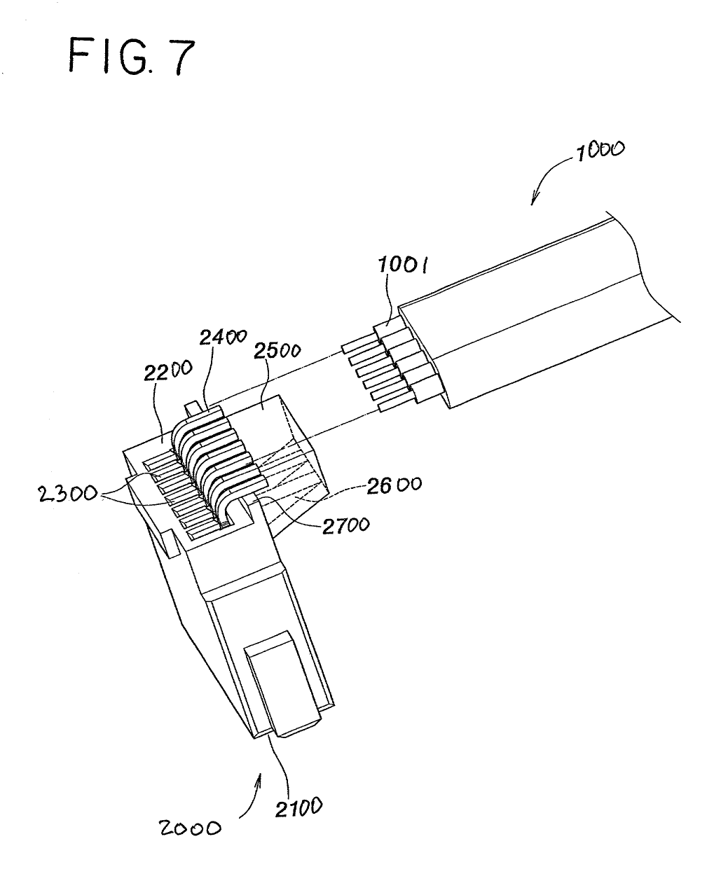

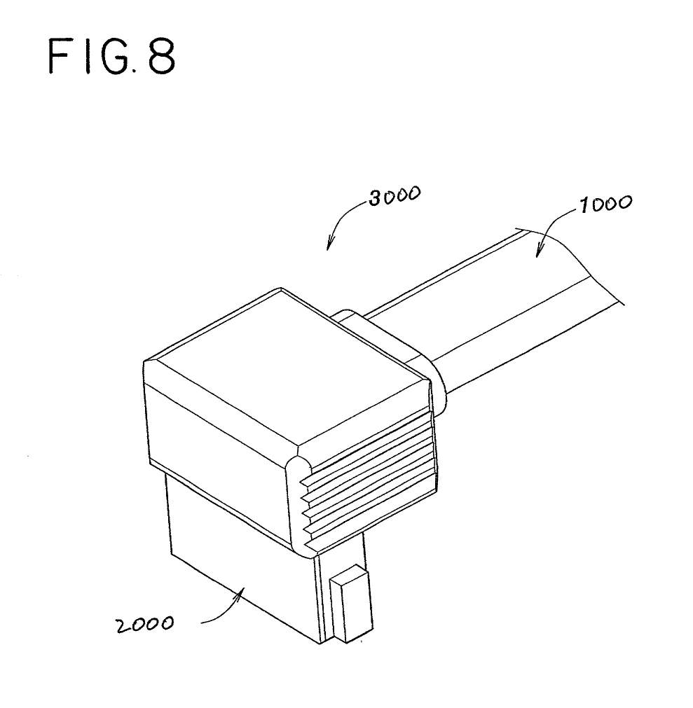

In another important aspect of the present invention, and as illustrated in FIGS. 7-10, the cable 1000 encloses a plurality of wires 1001 that are coupled to and positioned on the insulated connector housing 1002. The forward end of the connector housing has the front mating ends of a plurality of conductive terminals and, furthermore, conductive terminals 2100 are disposed at one end of the housing 2000, which are insertable into the corresponding socket of an opposing connector (not shown). Each of the terminals further has a terminating portion 2200 at its opposite extremity, preferably for soldering to exposed conductors of the cable 1000 in order to provide for signal transmission between the cable conductors and the terminals. The connector also includes a plurality of terminal-receiving passages, or channels, 2300 formed in the housing and disposed therein between the terminal front ends 2100 and the rear end 2200 of the housing. the terminals are disposed in these passages 2300 and the terminating portions 2400 of the terminals extend rearwardly therefrom to facilitate their joining to the cable wires 1001.

The connector housing 2000 preferably includes an extension block 2500 that projects vertically from the bottom section of the rear end portion 2200 of the housing and includes a plurality of grooves 2600 formed along the surface of the extension block 2500, the grooves 2600 providing for a larger area of surface contact for any portion molded thereto. After the cable wires 1001 are soldered or otherwise attached to the terminal termination portions 2400, a protective cover, or encasement portion 3000 is formed by molding, typically an overmolding process, and portions of the encasement portion 3000 fills the grooves 2600 of the extension block 2500 which increases the strength between the insulated housing 2000 and the encasement portion 3000, to thereby preventing the loosening of the encasement portion 3000 due to excessive plugging and unplugging force. When the cable 1000 is subjected to a pulling force, the pulling force is transferred to the encasement portion 3000 and because the encasement portion 3000 is anchored to the extension block 2500, the soldering joints between the wires 1001 and the termination leads 2400 remain unaffected.

Additionally, the termination leads 2400 extend an appropriate distance from the area of the rear end 2200 of the housing 2000 before extending in its right-angle bend and the subsequent horizontally aligned array to the extension block 2500 top surface. The terminals further extend over a horizontally projecting rib 2700 so that the rib 2700 serves as a brace when the wires 1001 are soldered to the terminal leads 2400 and also prevents the pressure-imposed contortion of the terminal leads 24 which would otherwise be situated in midair.

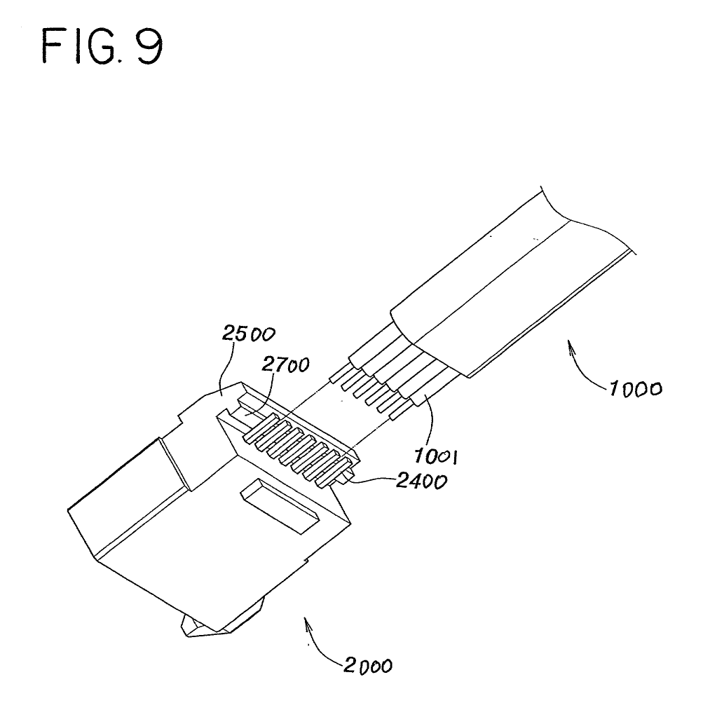

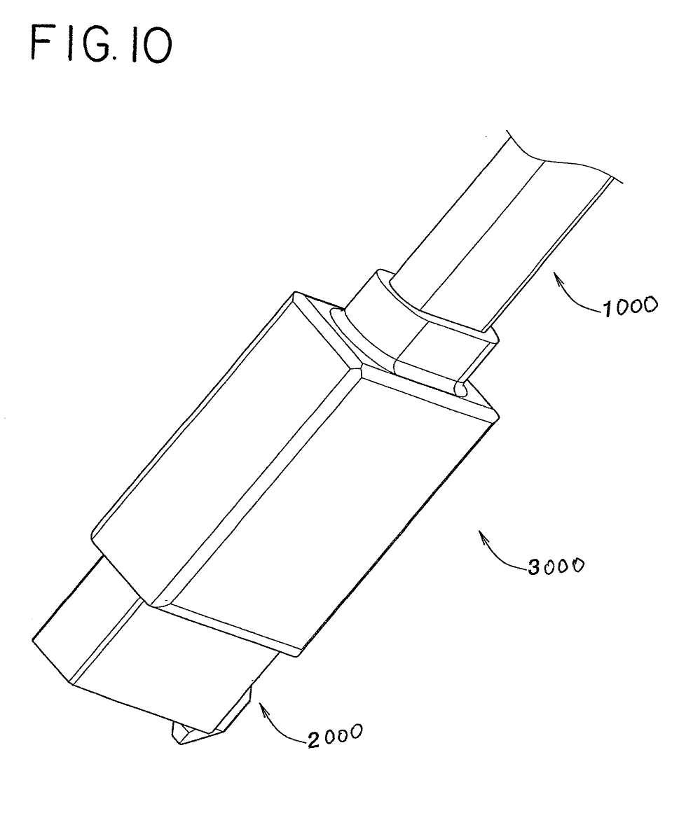

Referring to FIGS. 9 and 10, another embodiment of the invention is illustrated which differs from the embodiment just described by its “in-line” configuration, rather than a right-angle configuration. This embodiment includes a cable 1000 and a cable connector 2000 that couples to the cable 1000 and it differs from the aforementioned embodiment in that the extension block 25 projects horizontally from the said connector housing rear face 2200. the terminals extend from the housing and include termination portions 2400 in a horizontal array straight to the top end of the extension block 25 and across the rib 2700 that projects vertically from the top end of the said extension block 2500. This rib 2700 serves as a brace when the wires 1001 are soldered, or otherwise attached, to the terminal termination portions 2400.

In summation of the foregoing section, since the invention herein improves upon the shortcomings of conventional cable connectors such as not providing for the effective prevention of soldering point fatigue and breakage by utilizing an extension block 25 and molding to effectively increase anti-pull resilience and, consequently, in a manner that many This detailed description only elaborates the most preferred embodiments of the invention herein and shall not be construed as a limitation of the present invention and, therefore, all structural modifications based on the disclosed content and the figures shall remain protected within the scope and claims of the invention herein.

1. A cable connector for connecting a cable having a plurality of individual conductive wires therein to an opposing connector, the cable connector comprising:
a housing having a plurality of conductive terminals disposed therein, the housing having a hollow recess formed therein, the recess including a terminal section which houses termination ends of the terminals and a cable section which houses a termination end of the cable, the cable section of the recess including a pair of spaced-apart opposed sidewalls, the terminal section including a plurality of passages that receive said terminals therein, the termination ends of said terminals extending from said passages into said cable section, the cable section including a pair of first latch openings formed in the cable section two sidewalls, and a second latch opening interposed between and spaced apart from the first latch openings;
a cover plate for closing off said housing recess, the cover plate having a plurality of fastening members including a pair of first fastening members extending downward therefrom on opposite sides thereof, and a second fastening member interposed between and spaced apart from said first fastening members, whereby, when said cover plate is applied to said housing over said recess, said first fastening members are received within said first latch openings and said second fastening member is received within said second latch opening; and,
a cable including a plurality of conductive wires extending therein, the conductive wires having free ends that are attached to said terminal termination portions.

2. The cable connector as claimed in claim 1, wherein said cover plate includes a first cable-holding collar portion disposed at its rear end and said housing includes a second cable-holding collar portion disposed at its rear end, the first and second cable-holding collars being mated together when said cover plate is applied to said housing, said two cable-holding collar portions clamping the end of said cable.

3. The cable connector as claimed in claim 1, wherein said housing has an angled configuration, and said terminal and cable sections are joined together in a generally perpendicular fashion within said housing and said terminals are bent so that said termination leads extend from said terminal section into said cable section in an aligned array.

4. The cable connector as claimed in claim 1, wherein said housing has a linear configuration and said terminal and cable sections are aligned together along a common axis, said terminal leads extending in a horizontal array from said terminal section to said section.

5. The cable connector as claimed in claim 2, wherein said first and second cable-holding collars each have a plurality of grooves formed along their interior surfaces.

6. The cable connector as claimed in claim 1, further including a protective exterior strain relief portion molded over a portion of said cable and said first and second cable-holding collars.

7. The cable connector as claimed in claim 5, further including a protective exterior strain relief portion molded over a portion of said cable and said first and second cable-holding collars.

8. The cable connector as claimed in claim 1, wherein said housing further includes a support member disposed therein and extending within said recess crosswise to said terminal array, the support member supporting said terminal termination ends to facilitate the soldering of the said cable wires to said terminal leads.

9. The cable connector as claimed in claim 1, wherein each of said first fastening members includes an outwardly projecting latching tab, and said second fastening member includes an outwardly projecting tab, and wherein said first latch openings are spaced apart from said second latch opening a first preselected distance, and said latching tabs of said cover plate first and second fastening members are spaced apart a second preselected distance, said first and second preselected distances being equal.

10. The cable connector as claimed in claim 1, wherein said pair of first fastening members engage said housing in a direction generally parallel to a longitudinal axis of said housing and said second fastening member engages said housing in a direction crosswise to the housing longitudinal axis.

11. The cable connector as claimed in claim 5, further including a protective exterior strain relief portion molded over a portion of said cable and said first and second cable-holding collars.

12. A cable connector for connecting together a connector component to a cable, the cable having a plurality of individual wires extending longitudinally therethrough, the connector comprising: a connector housing having opposing front and rear ends, a plurality of passages extending lengthwise through the housing, an array of conductive terminals disposed in the housing passages, each of the terminals having opposing contact ends and termination ends, the termination ends extending out of said passages and free ends of said cable wires being terminated to said termination portions, the housing including a extension portion that extends lengwise underneath said termination portions, the extension portion including a support portion that extends crosswise to said wires, and a protective strain relief molded over said termination portions, extension portion and support portion to provide increased resistance to forces applied to said connector when said cable is pulled.

13. The cable conenctor of claim 12, wherein said housing extension portion extends from a lower surface of said housing at an angle to said housing, and said terminal termination portions are bent at an angle, and said strain relief cover said connector housing rear end and extends at an angle thereto over said extension portion.

14. The cable connector of claim 12, wherein said extension block includes a series of grooves formed therein and extending lengthwise of said connector.

15. The cable connector of claim 12, where said housing extension portion extends rearwardly of said connector housing.
